(19) United States
(12) Patent Application Publication
(10) Pub. No.: US 2015/0169600 A1
(43) Pub. Date: Jun. 18, 2015

(54) Interface display method and system for home gateway applicable to various display types

(71) Applicant: Hui Yu, Shenzhen (CN)

(72) Inventor: Hui Yu, Shenzhen (CN)

(73) Assignee: ZTE CORPORATION, Shenzhen, Guangdong (CN)

(21) Appl. No.: 14/401,551

(22) PCT Filed: Aug. 6, 2012
(86) PCT No.: PCT/CN2012/079733

§ 371 Date: Dec. 5, 2014

(30) Foreign Application Priority Data
Dec. 5, 2012 (CN) 201210157770.8

(51) Int. Cl. G06F 17/30; H04L 29/08

(52) U.S. Cl. CPC G06F 17/3089; H04L 67/02

(57) ABSTRACT

An interface display method and system for a home gateway applicable to various display types are described. The interface display method for a home gateway applicable to various display types includes receiving a page request sent from a Hypertext Transport Protocol (HTTP) browser and extracting display type information and an original page according to the page request, and forming a page adaptive to the current display type according to the original page and the display type information. By determining the display type information corresponding to an output screen according to a page request sent by an HTTP browser and converting the original page into a standard active script page adaptive to the current display type according to the display type information, the method and system provided herein guarantee the uniformity of interfaces and can convert interface display more conveniently and rapidly.

### TECHNICAL FIELD

The disclosure relates to the field of interface display, and more particularly to an interface display method and system for a home gateway applicable to various display types.

### BACKGROUND

Home gateway is defined to be an intelligent gateway serving between a networked information device used at home and an intelligent broadband access network. As a physical interface mainly for connecting all external access networks to a family and connecting a home network with the outside network, the home gateway serves as a platform for a residential user to obtain various home services (including existing services and the services which will be available in future).

For almost each currently available home gateway-class device, the interface display and function control are implemented in a manner that an external computer or another device visits the management page of a gateway via a home network. As technologies advance and the requirement from customers for product experience gets higher, a new home gateway-class product equipped with a liquid crystal display screen comes out, besides, some home gateways which are integrated with a digital high-definition interface or an audio and video separated interface can be connected with a television to present output interfaces through the screen of the television, resulting in a problem that it is necessary to develop a set of software for each output screen in a home gateway-class device equipped with a plurality of output screens so as to provide correct display in different output scenarios. Since there are three sets of functions and interfaces, labor cost is increased, user experience is degraded, and potential hazards may be caused to the software quality of the product.

### SUMMARY

The embodiments of the disclosure provide an interface display method and system for a home gateway applicable to various display types to address the problem in the conventional art that a plurality of sets of software have to be developed for a home gateway product equipped with a plurality of output screens according to different display types.

To achieve the foregoing purpose, an interface display method for a home gateway applicable to various display types is provided in an embodiment of the disclosure which includes:

an original page extraction step of receiving a page request sent from a Hypertext Transport Protocol (HTTP) browser and extracting display type information and an original page according to the page request; and

an interface display conversion step of forming a page adaptive to a current display type according to the display type information and the original page.

In the implementation of the method, the HTTP browser includes an internal HTTP browser built in a home gateway and/or an external HTTP browser on an electronic device connected with the home gateway.

In the implementation of the method, in the original page extraction step, extracting display type information and an original page according to the page request includes: recording display type information according to HTTP protocol information contained in the page request; and

finding the requested original page from a virtual host directory of the home gateway according to the page request.

In the implementation of the method, after the page request sent by the HTTP browser is received, the method further includes extracting an original standard active script page according to the page request received;

analyzing the original standard active script page to extract an area sub-page and a special functional sub-page;

extracting, according to the display type information, the area sub-page and the special functional sub-page, a corresponding display rule from a preset display configuration table in which display rules are stored corresponding to the area sub-pages and the special functional sub-pages under each display type;

extracting corresponding interface widgets from a preset interface element library according to the display rule, wherein a plurality of interface widgets are stored in the interface element library;

making a standard active script page adaptive to the current display type according to the display rule and the interface widgets;

parsing the standard active script page adaptive to the current display type to generate a standard HTTP page; and

outputting the standard HTTP page to the HTTP browser to display the standard HTTP page.

In the implementation of the method, after the page request sent by the HTTP browser is received, the method further includes extracting an original standard active script page according to the page request received;

parsing the original standard active script page to generate an original standard HTTP page;

analyzing the original standard HTTP page and extracting an area sub-page and a special functional sub-page;

extracting, according to the display type information, the area sub-page and the special functional sub-page, a corresponding display rule from a preset display configuration table in which display rules are stored corresponding to the area sub-pages and the special functional sub-pages under each display type;

extracting corresponding interface widgets from an interface element library according to the display rule, wherein a plurality of interface widgets are stored in the interface element library; and

making a standard HTTP page adaptive to the current display type according to the display rule and the interface widgets; and

outputting the standard HTTP page to the HTTP browser for to display the standard HTTP page.

An interface display system for a home gateway applicable to various display types is also provided in the disclosure which includes an original page extraction module and an interface display conversion module, wherein

the original page extraction module is configured to receive a page request sent from an HTTP browser and extract display type information and an original page according to the page request; and

the interface display conversion module is configured to form a page adaptive to the current display type according to the display type information and the original page.

In the implementation of the system, the HTTP browser includes an HTTP browser built in a home gateway and/or a browser on an electronic device connected with the home gateway.

In the implementation of the system, the original page extraction module includes:

a receiving unit configured to receive the page request sent by the HTTP browser;

a display type information extraction unit configured to record display type information according to HTTP protocol information contained in the page request received by the receiving unit; and

an original page extraction unit configured to find the requested original page from the virtual host directory of the home gateway according to the page request received by the receiving unit.

In the implementation of the system, the system further includes a script parsing module and a display module, wherein

the original page extraction module further extracts an original standard active script page according to the page request received; and

the interface display conversion module includes:
a storage unit in which a display configuration table and an interface element library are stored, wherein display rules corresponding to the area sub-pages and the special functional sub-pages under each display type are stored in the display configuration table, and a plurality of interface widgets are stored in the interface element library;
a page analysis unit configured to analyze the original standard active script page extracted by the original page extraction module and extract an area sub-page and a special functional sub-page;
a display rule extraction unit configured to extract a corresponding display rule from the display configuration table stored in the storage unit according to the display type information extracted by the original page extraction module and the area sub-page and the special functional sub-page extracted by the page analysis unit;
an interface widget extraction unit configured to extract corresponding interface widgets from the interface element library stored in the storage unit according to the display rule extracted by the display rule extraction unit; and
a current page assembling unit configured to make a standard active script page adaptive to the current display type according to the display rule extracted by the display rule extraction unit and the interface widgets extracted by the interface widget extraction unit;
the script parsing module parses the standard active script page made by the current assembling unit and adaptive to the current display type to generate a standard HTTP page; and
the display module displays the standard HTTP page generated by the script parsing module.

In the implementation of the system, the interface display system for a home gateway applicable to various display types further includes a script parsing module and a display module, wherein

the original page extraction module further extracts an original standard active script page according to the page request received;

the script parsing module parses the original standard active script page extracted by the original page extraction module to generate an original standard HTTP page; and

the interface display conversion module includes:
a storage unit in which a display configuration table and an interface element library are stored, wherein display rules corresponding to the area sub-pages and the special functional sub-pages under each display type are stored in the display configuration table, and a plurality of interface widgets are stored in the interface element library;
a page analysis unit configured to analyze the original standard HTTP page generated by the script parsing module and extract an area sub-page and a special functional sub-page;
a display rule extraction unit configured to extract a corresponding display rule from the display configuration table stored in the storage unit according to the display type information extracted by the original page extraction module and the area sub-page and the special functional sub-page extracted by the page analysis unit;
an interface widget extraction unit configured to extract corresponding interface widgets from the interface element library stored in the storage unit according to the display rule extracted by the display rule extraction unit; and
a current page assembling unit configured to make a standard HTTP page adaptive to the current display type according to the display rule extracted by the display rule extraction unit and the interface widgets extracted by the interface widget extraction unit; and

the display module outputs the standard HTTP page made by the current page assembling unit to the HTTP browser for the HTTP browser to display the standard HTTP page.

Compared with the conventional art, the method and system for a home gateway applicable to various display types provided herein guarantee interface uniformity and convert interface display more conveniently and rapidly by determining the display type information corresponding to an output screen according to a page request sent by an HTTP browser and converting the original page into a standard active script page adaptive to the current display type according to the display type information.

### BRIEF DESCRIPTION OF THE DRAWINGS

FIG. 1 is a flowchart illustrating a first embodiment of an interface display method for a home gateway applicable to various display types provided herein;

FIG. 2 is a flowchart illustrating an interface display conversion step included in a second embodiment of the interface display method for a home gateway applicable to various display types provided herein;

FIG. 3 is a flowchart illustrating a third embodiment of the interface display method for a home gateway applicable to various display types provided herein;

FIG. 4 is a flowchart illustrating a specific page making process implemented by an interface display service process;

FIG. 5 is a flowchart illustrating the generation of an interface element contained in an interface element library;

FIG. 6 is a block diagram illustrating the structure of a first embodiment of an interface display system for a home gateway applicable to various display types provided herein;

FIG. 7 is a block diagram illustrating the structure of a second embodiment of the interface display system for a home gateway applicable to various display types provided herein;

FIG. 8 is a block diagram illustrating the structure of a third embodiment of the interface display system for a home gateway applicable to various display types provided herein; and

FIG. 9 is a block diagram illustrating the structure of a fourth embodiment of the interface display system for a home gateway applicable to various display types provided herein.

### DETAILED DESCRIPTION

The object, the technical solution and the advantages of the disclosure will become more apparent from the following detailed description of specific embodiments when read in conjunction with accompanying drawings.

The specific implementation mode of the disclosure, which is not limited to the following description, is described below with reference to accompanying drawings.

An interface display method and system for a home gateway applicable to various display types are provided in the disclosure which overcome the defect that it is needed to develop a plurality of sets of interface software for a home gateway equipped with a plurality of output screens and which, by adopting a set of unified interface display system and automatically making a corresponding interface according to features of the currently connected output screens and a built-in rule, maximize the uniformity of interfaces.

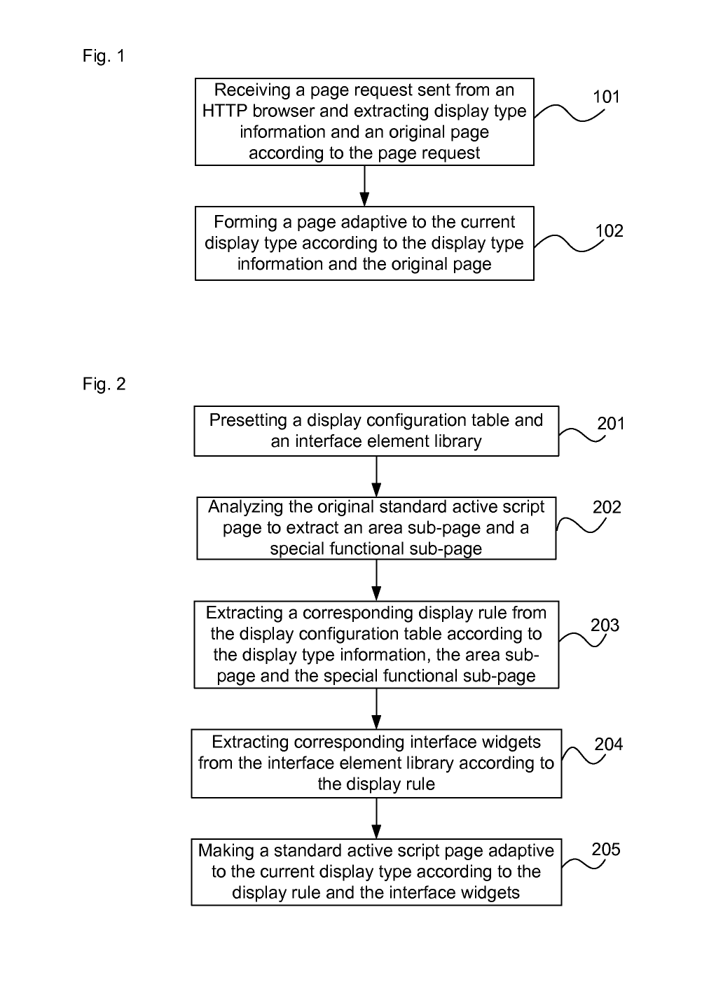

As shown in FIG. 1, a first embodiment of the interface display method for a home gateway applicable to various display types provided herein includes the following steps:

an original page extraction step 101 of receiving a page request sent from an HTTP browser and extracting display type information and an original page according to the page request; and

an interface display conversion step 102 of forming a page adaptive to the current display type according to the display type information and the original page.

In the first embodiment of the interface display method for a home gateway applicable to various display types provided herein, display type information corresponding to an output screen may be determined according to a page request sent by an HTTP browser, and an original page may be converted to a page adaptive to the current display type according to the display type information, thus overcoming the defect that existing home gateway equipped with a plurality of output screens needs a plurality of sets of interface software and guaranteeing interface uniformity while converting interface display more conveniently and rapidly.

The HTTP browser includes an internal HTTP browser built-in the home gateway and/or an external HTTP browser of an electronic device connected with the home gateway.

The external HTTP browser is a universal page browser based on World Wide Web Consortium (W3C) standards and is provided by the manufacturer of a browser or the manufacturer of a computer, a mobile telephone or another device; the device of the user, for example, the computer of the user, is connected with a home local area network provided by a home gateway to visit a predefined browser address via the external HTTP browser to visit and parse the webpage of the home gateway.

The internal HTTP browser is an embedded HTTP browser which runs on the home gateway as a process and is output to the liquid crystal display screen of the home gateway or a television output port.

The display via the liquid crystal display screen of the home gateway and the display by the home gateway via a television output port can be both considered as a local display by the home gateway, which are realized by executing a program in the software/hardware environment inside the home gateway, thus, the two kinds of screen output require the internal HTTP browser of the home gateway to visit a page. Such an internal HTTP browser is related to an embedded graphical programming environment and is difficult to transplant. However, the current mainstream embedded graphical environments for a home gateway only include embedded graphical interface editor (QTE) and Android in which an HTTP browser works nearly perfectly. After the home gateway is electrified and initialized, two internal HTTP browser are started to output one internal HTTP browser to the liquid crystal display screen of the home gateway and output the other internal HTTP browser to a television output interface, and the two internal HTTP browser both visit a defaulted address after being started.

In the implementation of the method, in the original page extraction step, extracting display type information and an original page according to the page request includes:

recording display type information according to the HTTP protocol information contained in the page request; and

finding the requested page from the virtual host directory of the home gateway according to the page request.

A second embodiment of the interface display method for a home gateway applicable to various display types provided herein is based on the first embodiment of the interface display method for a home gateway applicable to various display types provided herein.

As shown in FIG. 2, in the second embodiment of the interface display method for a home gateway applicable to various display types provided herein, the original page extraction step includes receiving a page request sent from an HTTP browser and extracting display type information and an original standard active script page according to the page request.

The interface display conversion step includes:

Step 201: presetting a display configuration table and an interface element library; wherein

display rules corresponding to the area sub-pages and the special functional sub-pages under each display type are stored in the display configuration table; and

a plurality of interface widgets are stored in the interface element library;

Step 202: analyzing the original standard active script page to extract an area sub-page and a special functional sub-page;

Step 203: extracting a corresponding display rule from the display configuration table according to the display type information, the area sub-page and the special functional sub-page;

Step 204: extracting corresponding interface widgets from the interface element library according to the display rule; and

Step 205: making a standard active script page adaptive to the current display type according to the display rule and the interface widgets.

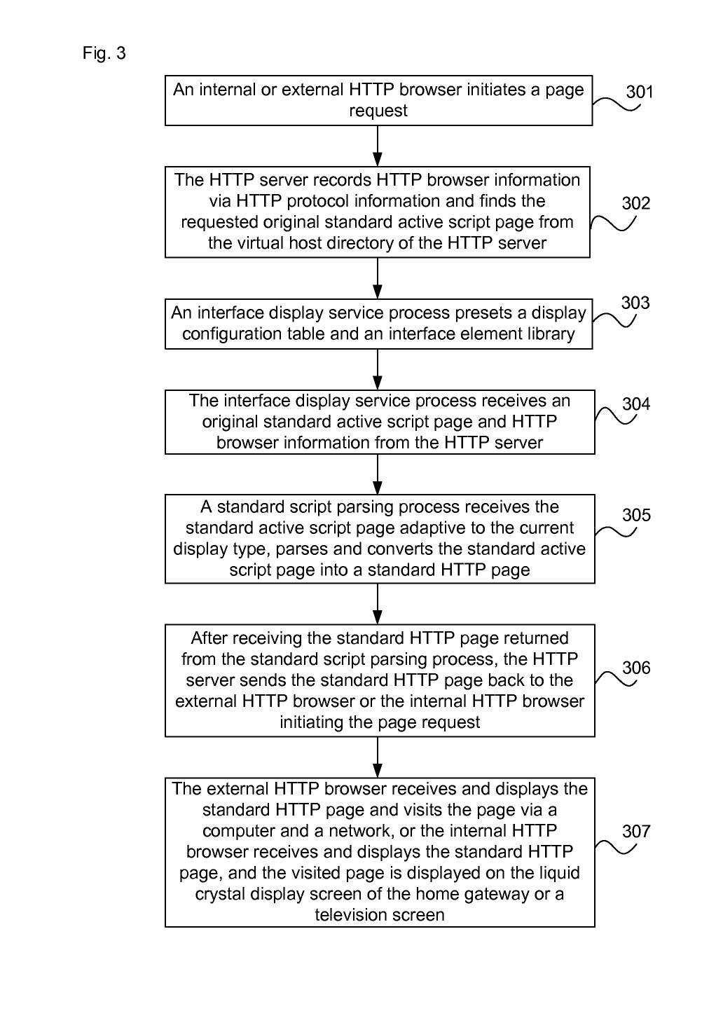

As shown in FIG. 3, a third embodiment of the interface display method for a home gateway applicable to various display types provided herein includes the following steps:

Step 301: a user accesses the internal network of the home gateway via a computer and a network cable, initiates a page request using the external HTTP browser of the computer or an internal HTTP browser which is displayed on a television output port or an liquid crystal display screen of the home gateway;

Step 302: the HTTP server in the home gateway receives a page request from the external HTTP browser or the internal HTTP browser, records HTTP browser information via HTTP protocol information and finds the requested original standard active script page from the virtual host directory of the HTTP server, wherein the original standard active script page may be a Hypertext Preprocessor (PHP) page, a Java Server Page (JSP), an Active Server Page (ASP) and the like, and the HTTP browser information includes display type information;

Step 303: an interface display service process presets a display configuration table and an interface element library; wherein

display rules corresponding to the area sub-pages and the special functional sub-pages under each display type are stored in the display configuration table; and

a plurality of interface widgets are stored in the interface element library;

Step 304: the interface display service process receives an original standard active script page and HTTP browser information from the HTTP server;

the interface display service process determines which kind of browser of which kind of screen sends the page request according to the display type information, searches the display configuration table for the display rule corresponding to the display type information, searches the interface element table to extract desired interface widgets from the interface element table and assembles the interface widgets into a standard active script page adaptive to the current display type;

Step 305: a standard script parsing process receives the standard active script page adaptive to the current display type, parses and converts the standard active script page into a standard HTTP page and returns the standard HTTP page to the HTTP server;

Step 306: after receiving the standard HTTP page returned from the standard script parsing process, the HTTP server sends the standard HTTP page back to the external HTTP browser or the internal HTTP browser which initiated the page request;

Step 307: the external HTTP browser receives and displays the standard HTTP page and visits the page via a computer and a network, or the internal HTTP browser receives and displays the standard HTTP page, and a visited page is displayed on the liquid crystal display screen of the home gateway or a television screen.

In the third embodiment of the interface display method for a home gateway applicable to various display types, the sequence of Step 304 and Step 305 can be exchanged, that is, script analysis may be carried out before or after interface conversion.

In the third embodiment, the display configuration table is a table for the interface display service process to make a query, the table including one or more display rules; the display rule indicates which interface page should be output when a page request is output from a certain output screen or a certain HTTP browser. The display rule not only puts forward requirements on display position, layout and size, but also indicates the functions that can be provided by an output screen. For example, as the liquid crystal display screen of a home gateway can not be large in size and not excellent in display quality, some entertainment functions, such as a video play function, cannot be displayed when visited by a liquid crystal display screen browser.

In the third embodiment, the interface element library is a software library consisting of a great many of scripts or HTTP code segments, each display or function of the home gateway is packaged into a segment of function, and if it is further needed to control lower-layer hardware, for example, open a radio function or monitor a download rate, then the operation needs to be compiled into a library using another substrate language and called using a script code segment. In this way, when several functions are needed, code segments are extracted from the interface element library and added to an interface to be assembled. It should be noted that almost all these interface elements are not allowed to be located using absolute coordinates so as to be adaptive to screens of different sizes.

A fourth embodiment of the interface display method for a home gateway applicable to various display types provided herein includes the following steps:

an original page extraction step of receiving a page request sent from an HTTP browser and extracting display type information and an original standard active script page according to the page request;

a script parsing step of parsing the original standard active script page to generate an original standard HTTP page;

an interface display conversion step including:
presetting a display configuration table and an interface element library, wherein
   display rules corresponding to the area sub-pages and the special functional sub-pages under each display type are stored in the display configuration table, and
   a plurality of interface widgets are stored in the interface element library,
analyzing the original standard HTTP page and extracting an area sub-page and a special functional sub-page,
extracting a corresponding display rule from the display configuration table according to the display type information, the area sub-page and the special functional sub-page,
extracting corresponding interface widgets from the interface element library according to the display rule, and
making a standard HTTP page adaptive to the current display type according to the display rule and the interface widgets; and

a display step of outputting the standard HTTP page to the HTTP browser for the HTTP browser to display the standard HTTP page.

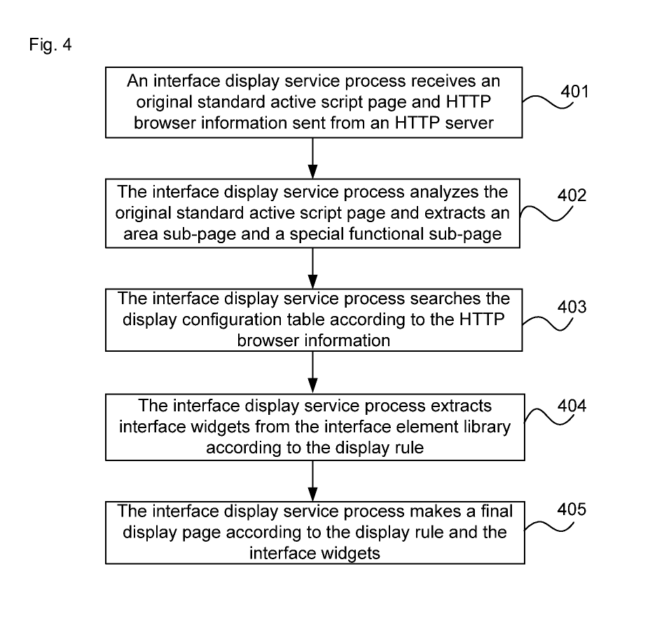

As shown in FIG. 4, according to a specific embodiment, a specific page assembling flow completed by the interface display service process includes:

Step 401: the interface display service process receives the original standard active script page and the HTTP browser information sent from the HTTP server, wherein

the HTTP browser information includes display type information and the window size of the browser;

the display type information only indicates whether or not an output screen is the liquid crystal display screen of a computer, or the liquid crystal display screen of the home gateway, or the output screen of a television;

the content of the original standard active script page includes the area sub-pages of the page, including the head, the body and the footer of the page, and sub-pages of specific functional areas and simple HTTP elements needing no conversion;

Step 402: the interface display service process analyzes the original standard active script page and extracts an area sub-page and a special functional sub-page;

the interface display service process can be implemented using any compiled or interpreted programming language and finally run as an independent process or as a plug-in of the HTTP server or as a standard dynamic script program;

the interface display service process is preferably realized using a suite of active script page programs, for example, PHP, JSP or ASP to achieve the following advantage that the interface display service process can execute an interface display service by means of a standard dynamic script parsing service and can be directly embedded into existing HTTP server and a standard script analysis service plug-in for use as the connection with the HTTP server is excellent;

Step 403: the interface display service process searches the display configuration table according to the HTTP browser information;

the display configuration table is a multi-level two-dimensional table, in other words, the combination of a plurality of associated tables.

the first-level table of the display configuration table only has three entries, that is, when a visit is performed by the external HTTP browser, or when a display is present by the liquid crystal display screen of the home gateway, or when an output is implemented through connection with a television, second-level tables corresponding to the entries in the first-level table should be looked up by the display rule corresponding to the entries in the first-level table. It can be seen that three second-level tables are needed, and the number of the entries contained in each of the second-level tables is not fixed and the content in each of the second-level tables includes the interface display elements and the interface function elements into which a position sub-page or a functional sub-page should be interpreted and also includes information including layout position, window size, image, background image, foreground color, background color, font name and font size; and a display rule corresponding to the display type information can be obtained after the area sub-pages and the special functional sub-pages of the original standard active script page are found in the display configuration table and converted;

Step 404: the interface display service process extracts interface widgets from the interface element library according to the display rule;

the interface widget is a code segment in which a certain display or functional element is encapsulated, for example, an interface widget which indicates operator information and an interface widget which indicates the current signal intensity of a wireless network; an interface widget interacting with the operating system of the home gateway consists of a library of script languages and lower-layer compiled languages so as to overcome the defect that a system service cannot be visited by script languages;

Step 405: the interface display service process constructs the final display page according to the display rule and the interface widgets, the display page, which may be the final HTTP page or an active script page such as a PHP, a JSP, an ASP and so on, is then sent to a standard script parsing process and finally returned to the HTTP browser to be displayed.

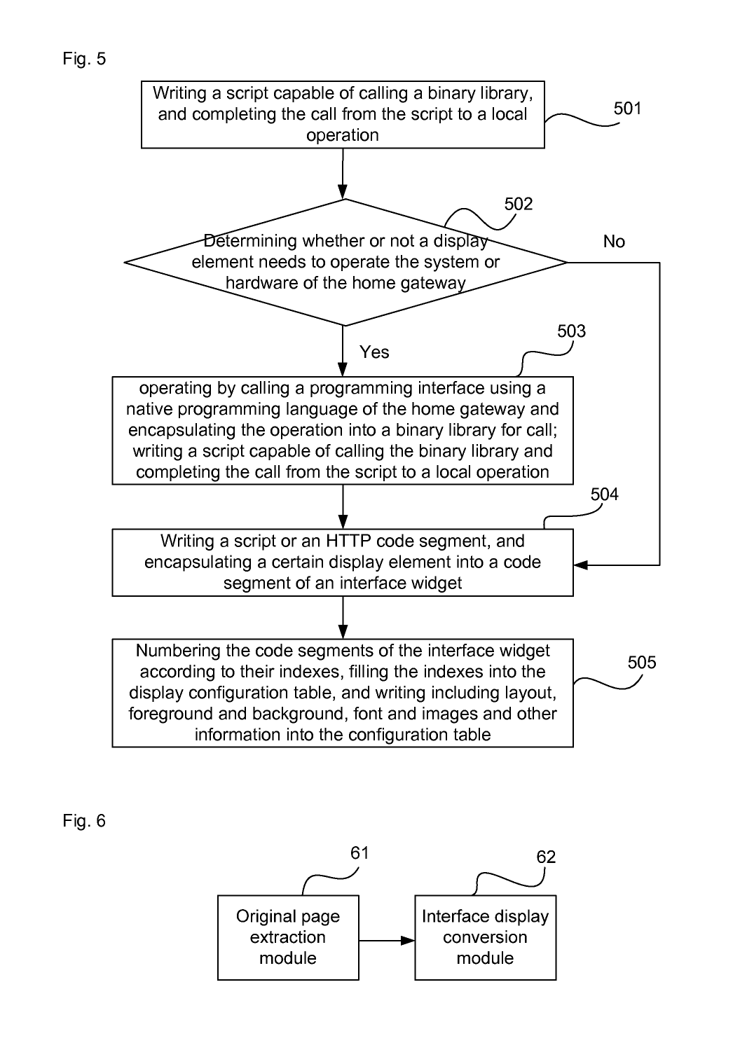

As shown in FIG. 5, the flow of the generation of the interface element in the interface element library includes:

Step 501: display elements are collected according to three display types, and any display element or page can be added when needed during a page making process;

Step 502: whether or not the display element needs to operate the system or hardware of the home gateway, for example, whether or not to open or close a Bluetooth function, is determined, if needing, the flow proceeds to Step 503, otherwise, the flow proceeds to Step 504;

Step 503: an operation is implemented by a programming interface which is called using a native programming language of the home gateway, and the operation is encapsulates into a binary library for call; a script capable of calling the binary library is written, and the call from the script to a local operation is made;

Step 504: a script or an HTTP code segment is written, and a certain display element is encapsulated into a code segment of an interface widget;

Step 505: code segments of the interface widget are numbered according to their indexes, the indexes are filled into the display configuration table, and information, including layout, foreground and background, font and images are written into the configuration table.

As shown in FIG. 6, a first embodiment of the interface display system for a home gateway applicable to various display types provided herein includes:

an original page extraction module 61 configured to receive a page request sent from an HTTP browser and extract display type information and an original page according to the page request; and

an interface display conversion module 62 configured to form a page adaptive to the current display type according to the display type information and the original page.

In accordance with a specific embodiment, the original page extraction module includes a receiving unit, a display type information extraction unit and an original page extraction unit, wherein

the receiving unit is configured to receive the page request sent by the HTTP browser;

the display type information extraction unit is configured to record display type information according to the HTTP protocol information contained in the page request; and

the original page extraction unit configured to find the requested original page from the virtual host directory of the home gateway according to the page request.

A second embodiment of the interface display system for a home gateway applicable to various display types provided herein is based on the first embodiment of the interface display system for a home gateway applicable to various display types provided herein.

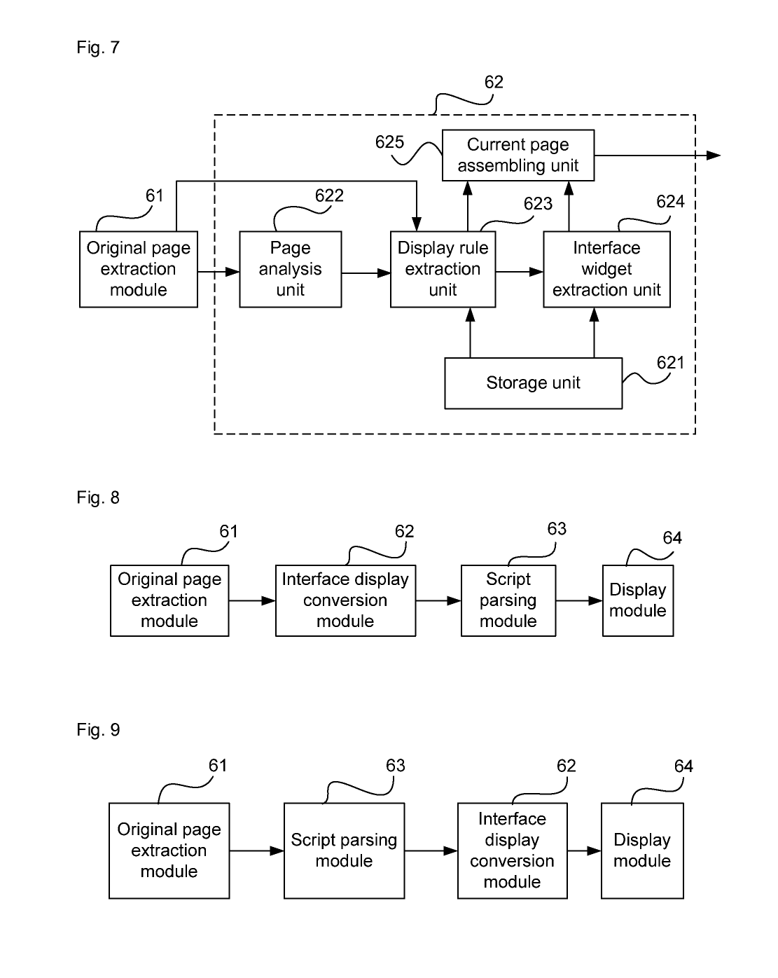

As shown in FIG. 7, in the second embodiment of the interface display system for a home gateway applicable to various display types provided herein,

the original page extraction module 61 is configured to receive a page request sent from the HTTP browser and extract display type information and an original standard active script page according to the page request; and

the interface display conversion module 62 includes:
a storage unit 621 in which a display configuration table and an interface element library are stored, wherein display rules corresponding to the area sub-pages and the special functional sub-pages under each display type are stored in the display configuration table, and a plurality of interface widgets are stored in the interface element library;
a page analysis unit 622 configured to analyze the original standard active script page and extract an area sub-page and a special functional sub-page;
a display rule extraction unit 623 configured to extract, from the display configuration table, a corresponding display rule according to the display type information, the area sub-page and the special functional sub-page;
an interface widget extraction unit 624 configured to extract corresponding interface widgets from the interface element library according to the display rule; and
a current page assembling unit 625 configured to make a standard active script page adaptive to the current display type according to the display rule and the interface widgets.

A third embodiment of the interface display system for a home gateway applicable to various display types provided herein is based on the first or second embodiment of the interface display system for a home gateway applicable to various display types provided herein.

As shown in FIG. 8, a third embodiment of the interface display system for a home gateway applicable to various display types provided herein further includes:

a script parsing module 63 configured to parse the standard active script page adaptive to the current display type to generate a standard HTTP page; and

a display module 64 configured to display the HTTP page.

A fourth embodiment of the interface display system for a home gateway applicable to various display types provided herein is based on the first or second embodiment of the interface display system for a home gateway applicable to various display types provided herein.

FIG. 9 is a block diagram illustrating the structure of a fourth embodiment of the interface display system for a home gateway applicable to various display types provided herein.

As shown in FIG. 9, the fourth embodiment of the interface display system for a home gateway applicable to various display types further includes a script parsing module 63 and a display module 64, wherein

the original page extraction module 61 is configured to receive a page request sent from the HTTP browser and extract display type information and an original standard active script page according to the page request; and

the script parsing module 63 is configured to parse the original standard active script page to generate an original standard HTTP page; and

the interface display conversion module 62 includes:
a storage unit in which a display configuration table and an interface element library are stored, wherein display rules corresponding to the area sub-pages and the special functional sub-pages under each display type are stored in the display configuration table, and a plurality of interface widgets are stored in the interface element library;
a page analysis unit configured to analyze the original standard HTTP page and extract an area sub-page and a special functional sub-page;
a display rule extraction unit configured to extract, from the display configuration table, a corresponding display rule according to the display type information, the area sub-page and the special functional sub-page;
an interface widget extraction unit configured to extract corresponding interface widgets from the interface element library according to the display rule; and
a current page assembling unit configured to make a standard HTTP page adaptive to the current display type according to the display rule and the interface widgets; and

the display module 64 is configured to output the standard HTTP page to the HTTP browser for the HTTP browser to display the standard HTTP page.

The interface display method and system for a home gateway adaptive to a plurality of display types provided herein have the following advantages that:

by unifying the interface display of a plurality of output screens, the method and system highly unify the final visual effect presented to a user and therefore improve user experience;

there is only one set of interface program, therefore, only one set of development resources is needed, thus greatly saving the labor cost in software development while guaranteeing the quality of software; and

by separating the upper-layer interface display from the lower-layer embedded graphical environment, a unified interface program adaptive to different embedded graphical environments is developed, thus realizing the platform of the interface development for home gateway-class devices and speeding up the development of new devices.

The mentioned above are merely preferred embodiments of the disclosure but should not be construed as limitation to the protection scope of the disclosure. It should be appreciated by those ordinary skills in the art that a variety of modifications, variations and equivalents can be devised without departing from the spirit and scope of the disclosure, and all the modifications, variations and equivalents devised should fall within the protection range of the disclosure.

What is claimed is:

1. An interface display method for a home gateway applicable to various display types, comprising:
receiving a page request sent from a Hypertext Transport Protocol (HTTP) browser and extracting display type information and an original page according to the page request; and
forming a page adaptive to a current display type according to the display type information and the original page.

2. The interface display method for a home gateway applicable to various display types according to claim 1, wherein the HTTP browser includes an internal HTTP browser built in a home gateway and/or an external HTTP browser on an electronic device connected with the home gateway.

3. The interface display method for a home gateway applicable to various display types according to claim 1, wherein extracting the display type information and the original page according to the page request comprises:
recording the display type information according to HTTP protocol information contained in the page request; and
finding the original page requested from a virtual host directory of a home gateway according to the page request.

4. The interface display method for a home gateway applicable to various display types according to claim 1, wherein after the page request sent by the HTTP browser is received, the method further comprising:
extracting an original standard active script page according to the page request received;
analyzing the original standard active script page to extract an area sub-page and a special functional sub-page;
extracting, according to the display type information, the area sub-page and the special functional sub-page, a corresponding display rule from a preset display configuration table in which display rules are stored corresponding to area sub-pages and special functional sub-pages under each display type;
extracting corresponding interface widgets from a preset interface element library according to the corresponding display rule, wherein a plurality of interface widgets are stored in the preset interface element library;
making a standard active script page adaptive to the current display type according to the corresponding display rule and the corresponding interface widgets;
parsing the standard active script page adaptive to the current display type to generate a standard HTTP page; and
outputting the standard HTTP page to the HTTP browser to display the standard HTTP page.

5. The interface display method for a home gateway applicable to various display types according to claim 1, wherein after the page request sent by the HTTP browser is received, the method further comprising:
extracting an original standard active script page according to the page request received;
parsing the original standard active script page to generate an original standard HTTP page;
analyzing the original standard HTTP page and extracting an area sub-page and a special functional sub-page;
extracting, according to the display type information, the area sub-page and the special functional sub-page, a corresponding display rule from a preset display configuration table in which display rules are stored corresponding to area sub-pages and special functional sub-pages under each display type;
extracting corresponding interface widgets from an interface element library according to the corresponding display rule, wherein a plurality of interface widgets are stored in the interface element library; and
making a standard active script page adaptive to the current display type according to the corresponding display rule and the corresponding interface widgets;
outputting the original standard HTTP page to the HTTP browser to display the standard HTTP page.

6. An interface display system for a home gateway applicable to various display types, comprising an original page extraction module and an interface display conversion module, wherein
the original page extraction module is configured to receive a page request sent from a Hypertext Transport Protocol (HTTP) browser and extract display type information and an original page according to the page request; and
the interface display conversion module is configured to form a page adaptive to a current display type according to the display type information and the original page.

7. The interface display system for a home gateway applicable to various display types according to claim 6, wherein the HTTP browser includes an HTTP browser built in a home gateway and/or a browser on an electronic device connected with the home gateway.

8. The interface display system for a home gateway applicable to various display types according to claim 6, wherein the original page extraction module comprises:
a receiving unit configured to receive the page request sent by the HTTP browser;
a display type information extraction unit configured to record the display type information according to HTTP protocol information contained in the page request received by the receiving unit; and
an original page extraction unit configured to find the original page requested from a virtual host directory of a home gateway according to the page request received by the receiving unit.

9. The interface display system for a home gateway applicable to various display types according to claim 6, further comprising a script parsing module and a display module, wherein
the original page extraction module is further configured to extract an original standard active script page according to the page request received; and
the interface display conversion module comprises:
a storage unit in which a display configuration table and an interface element library are stored, wherein display rules corresponding to area sub-pages and special functional sub-pages under each display type are stored in the display configuration table, and a plurality of interface widgets are stored in the interface element library;
a page analysis unit configured to analyze the original standard active script page extracted by the original page extraction module and extract an area sub-page and a special functional sub-page;
a display rule extraction unit configured to extract a corresponding display rule from the display configuration table stored in the storage unit according to the display type information extracted by the original page extraction module and the area sub-page and the special functional sub-page extracted by the page analysis unit;
an interface widget extraction unit configured to extract corresponding interface widgets from the interface element library stored in the storage unit according to the corresponding display rule extracted by the display rule extraction unit; and
a current page assembling unit configured to make a standard active script page adaptive to the current display type according to the corresponding display rule extracted by the display rule extraction unit and the corresponding interface widgets extracted by the interface widget extraction unit;
the script parsing module is configured to parse the standard active script page made by the current assembling unit and adaptive to the current display type to generate a standard HTTP page; and
the display module is configured to display the standard HTTP page generated by the script parsing module.

10. The interface display system for a home gateway applicable to various display types according to claim 6, further comprising a script parsing module and a display module, wherein
the original page extraction module is further configured to extract an original standard active script page according to the page request received;
the script parsing module is configured to parse the original standard active script page extracted by the original page extraction module to generate an original standard HTTP page; and
the interface display conversion module comprises:
a storage unit in which a display configuration table and an interface element library are stored, wherein display rules corresponding to area sub-pages and special functional sub-pages under each display type are stored in the display configuration table, and a plurality of interface widgets are stored in the interface element library;
a page analysis unit configured to analyze the original standard HTTP page generated by the script parsing module and extract an area sub-page and a special functional sub-page;
a display rule extraction unit configured to extract a corresponding display rule from the display configuration table stored in the storage unit according to the display type information extracted by the original page extraction module and the area sub-page and the special functional sub-page extracted by the page analysis unit;
an interface widget extraction unit configured to extract corresponding interface widgets from the interface element library stored in the storage unit according to the corresponding display rule extracted by the display rule extraction unit; and
a current page assembling unit configured to make a standard HTTP page adaptive to the current display type according to the corresponding display rule extracted by the display rule extraction unit and the corresponding interface widgets extracted by the interface widget extraction unit; and
the display module is configured to output the standard HTTP page made by the current page assembling unit to the HTTP browser to display the standard HTTP page.

11. The interface display method for a home gateway applicable to various display types according to claim 2, wherein after the page request sent by the HTTP browser is received, the method further comprising:
extracting an original standard active script page according to the page request received;
analyzing the original standard active script page to extract an area sub-page and a special functional sub-page;
extracting, according to the display type information, the area sub-page and the special functional sub-page, a corresponding display rule from a preset display configuration table in which display rules are stored corresponding to area sub-pages and special functional sub-pages under each display type;
extracting corresponding interface widgets from a preset interface element library according to the corresponding display rule, wherein a plurality of interface widgets are stored in the preset interface element library;
making a standard active script page adaptive to the current display type according to the corresponding display rule and the corresponding interface widgets;
parsing the standard active script page adaptive to the current display type to generate a standard HTTP page; and
outputting the standard HTTP page to the HTTP browser to display the standard HTTP page.

12. The interface display method for a home gateway applicable to various display types according to claim 3, wherein after the page request sent by the HTTP browser is received, the method further comprising:
extracting an original standard active script page according to the page request received;
analyzing the original standard active script page to extract an area sub-page and a special functional sub-page;
extracting, according to the display type information, the area sub-page and the special functional sub-page, a corresponding display rule from a preset display configuration table in which display rules are stored corresponding to area sub-pages and special functional sub-pages under each display type;
extracting corresponding interface widgets from a preset interface element library according to the corresponding display rule, wherein a plurality of interface widgets are stored in the preset interface element library;
making a standard active script page adaptive to the current display type according to the corresponding display rule and the corresponding interface widgets;
parsing the standard active script page adaptive to the current display type to generate a standard HTTP page; and
outputting the standard HTTP page to the HTTP browser to display the standard HTTP page.

13. The interface display method for a home gateway applicable to various display types according to claim 2, wherein after the page request sent by the HTTP browser is received, the method further comprising:
extracting an original standard active script page according to the page request received;
parsing the original standard active script page to generate an original standard HTTP page;
analyzing the original standard HTTP page and extracting an area sub-page and a special functional sub-page;
extracting, according to the display type information, the area sub-page and the special functional sub-page, a corresponding display rule from a preset display configuration table in which display rules are stored corresponding to area sub-pages and special functional sub-pages under each display type;
extracting corresponding interface widgets from an interface element library according to the corresponding display rule, wherein a plurality of interface widgets are stored in the interface element library; and
making a standard active script page adaptive to the current display type according to the corresponding display rule and the corresponding interface widgets;
outputting the original standard HTTP page to the HTTP browser to display the standard HTTP page.

14. The interface display method for a home gateway applicable to various display types according to claim 3, wherein after the page request sent by the HTTP browser is received, the method further comprising:
extracting an original standard active script page according to the page request received;
parsing the original standard active script page to generate an original standard HTTP page;
analyzing the original standard HTTP page and extracting an area sub-page and a special functional sub-page;
extracting, according to the display type information, the area sub-page and the special functional sub-page, a corresponding display rule from a preset display configuration table in which display rules are stored corresponding to area sub-pages and special functional sub-pages under each display type;
extracting corresponding interface widgets from an interface element library according to the corresponding display rule, wherein a plurality of interface widgets are stored in the interface element library; and
making a standard active script page adaptive to the current display type according to the corresponding display rule and the corresponding interface widgets;
outputting the original standard HTTP page to the HTTP browser to display the standard HTTP page.

15. The interface display system for a home gateway applicable to various display types according to claim 7, further comprising a script parsing module and a display module, wherein
the original page extraction module is further configured to extract an original standard active script page according to the page request received; and
the interface display conversion module comprises:
a storage unit in which a display configuration table and an interface element library are stored, wherein display rules corresponding to area sub-pages and special functional sub-pages under each display type are stored in the display configuration table, and a plurality of interface widgets are stored in the interface element library;
a page analysis unit configured to analyze the original standard active script page extracted by the original page extraction module and extract an area sub-page and a special functional sub-page;
a display rule extraction unit configured to extract a corresponding display rule from the display configuration table stored in the storage unit according to the display type information extracted by the original page extraction module and the area sub-page and the special functional sub-page extracted by the page analysis unit;
an interface widget extraction unit configured to extract corresponding interface widgets from the interface element library stored in the storage unit according to the corresponding display rule extracted by the display rule extraction unit; and
a current page assembling unit configured to make a standard active script page adaptive to the current display type according to the corresponding display rule extracted by the display rule extraction unit and the corresponding interface widgets extracted by the interface widget extraction unit;
the script parsing module is configured to parse the standard active script page made by the current assembling unit and adaptive to the current display type to generate a standard HTTP page; and
the display module is configured to display the standard HTTP page generated by the script parsing module.

16. The interface display system for a home gateway applicable to various display types according to claim 8, further comprising a script parsing module and a display module, wherein
the original page extraction module is further configured to extract an original standard active script page according to the page request received; and
the interface display conversion module comprises:
a storage unit in which a display configuration table and an interface element library are stored, wherein display rules corresponding to area sub-pages and special functional sub-pages under each display type are stored in the display configuration table, and a plurality of interface widgets are stored in the interface element library;
a page analysis unit configured to analyze the original standard active script page extracted by the original page extraction module and extract an area sub-page and a special functional sub-page;
a display rule extraction unit configured to extract a corresponding display rule from the display configuration table stored in the storage unit according to the display type information extracted by the original page extraction module and the area sub-page and the special functional sub-page extracted by the page analysis unit;
an interface widget extraction unit configured to extract corresponding interface widgets from the interface element library stored in the storage unit according to the corresponding display rule extracted by the display rule extraction unit; and
a current page assembling unit configured to make a standard active script page adaptive to the current display type according to the corresponding display rule extracted by the display rule extraction unit and the corresponding interface widgets extracted by the interface widget extraction unit;
the script parsing module is configured to parse the standard active script page made by the current assembling unit and adaptive to the current display type to generate a standard HTTP page; and
the display module is configured to display the standard HTTP page generated by the script parsing module.

17. The interface display system for a home gateway applicable to various display types according to claim 7, further comprising a script parsing module and a display module, wherein
the original page extraction module is further configured to extract an original standard active script page according to the page request received;
the script parsing module is configured to parse the original standard active script page extracted by the original page extraction module to generate an original standard HTTP page; and
the interface display conversion module comprises:
a storage unit in which a display configuration table and an interface element library are stored, wherein display rules corresponding to area sub-pages and special functional sub-pages under each display type are stored in the display configuration table, and a plurality of interface widgets are stored in the interface element library;
a page analysis unit configured to analyze the original standard HTTP page generated by the script parsing module and extract an area sub-page and a special functional sub-page;
a display rule extraction unit configured to extract a corresponding display rule from the display configuration table stored in the storage unit according to the display type information extracted by the original page extraction module and the area sub-page and the special functional sub-page extracted by the page analysis unit;
an interface widget extraction unit configured to extract corresponding interface widgets from the interface element library stored in the storage unit according to the corresponding display rule extracted by the display rule extraction unit; and
a current page assembling unit configured to make a standard HTTP page adaptive to the current display type according to the corresponding display rule extracted by the display rule extraction unit and the corresponding interface widgets extracted by the interface widget extraction unit; and
the display module is configured to output the standard HTTP page made by the current page assembling unit to the HTTP browser to display the standard HTTP page.

18. The interface display system for a home gateway applicable to various display types according to claim 8, further comprising a script parsing module and a display module, wherein
the original page extraction module is further configured to extract an original standard active script page according to the page request received;
the script parsing module is configured to parse the original standard active script page extracted by the original page extraction module to generate an original standard HTTP page; and
the interface display conversion module comprises:
a storage unit in which a display configuration table and an interface element library are stored, wherein display rules corresponding to area sub-pages and special functional sub-pages under each display type are stored in the display configuration table, and a plurality of interface widgets are stored in the interface element library;
a page analysis unit configured to analyze the original standard HTTP page generated by the script parsing module and extract an area sub-page and a special functional sub-page;
a display rule extraction unit configured to extract a corresponding display rule from the display configuration table stored in the storage unit according to the display type information extracted by the original page extraction module and the area sub-page and the special functional sub-page extracted by the page analysis unit;
an interface widget extraction unit configured to extract corresponding interface widgets from the interface element library stored in the storage unit according to the corresponding display rule extracted by the display rule extraction unit; and
a current page assembling unit configured to make a standard HTTP page adaptive to the current display type according to the corresponding display rule extracted by the display rule extraction unit and the corresponding interface widgets extracted by the interface widget extraction unit; and
the display module is configured to output the standard HTTP page made by the current page assembling unit to the HTTP browser to display the standard HTTP page.
